(19) United States
(12) Patent Application Publication
(10) Pub. No.: US 2009/0144094 A1
(43) Pub. Date: Jun. 4, 2009

(54) Systems And Methods For Hospital Confinement And Care Industry Insurance Policy

(76) Inventors: Thomas O. Morey, Columbus, GA (US); Mark C. Massey, Auburn, AL (US); Katherine L. Gant, Columbus, GA (US); Melanie C. Averett, Richland, GA (US); Deborah T. Grantham, Woodland, GA (US); Rita S. Golden, Columbus, GA (US); JoAnn King, Columbus, GA (US); Karen S. Riedel, Smith Station, AL (US); Wendy L. Herndon, Columbus, GA (US); Louise W. Gilliam, Columbus, GA (US); Michael R. Okula, Columbus, GA (US); Jennifer M. McMullin, Phenix City, AL (US)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 11/948,768

(22) Filed: Nov. 30, 2007

Related U.S. Application Data
(60) Provisional application No. 60/868,256, filed on Dec. 1, 2006.

(51) Int. Cl. G06Q 40/00

(52) U.S. Cl. 705/4

(57) ABSTRACT

In various disclosed embodiments, systems, methods, and hospital confinement and care insurance policies can be used to provide coverage to an ill person confined to a hospital or a caregiver providing assistance to such ill person to compensate for lost income due to absence from work.

### CROSS-REFERENCE TO RELATED APPLICATION

The present application claims the full benefit and priority of U.S. provisional patent application Ser. No. 60/868,256, filed Dec. 1, 2006, entitled Systems And Methods For Hospital Confinement And Care Insurance Policy. The entire contents of the aforementioned application is incorporated herein by reference.

### BACKGROUND OF THE INVENTION

1. Field of the Invention

This invention relates to the field of technologies for offering and processing claims under an insurance policy, and more particularly, an insurance policy that provides coverage for lost income to an ill person for hospital confinement or a caregiver providing assistance to the ill person.

2. Description of the Related Art

Most workers at some point over their careers miss work due to illness or caring for a dependent or family member that is ill. Although health insurance may cover the medical expenses of the person who is ill, the ill person often loses income due to inability to work. A caregiver of such ill person must often take unpaid leave from work. Thus, in addition to coverage of loss of pay to the person who is ill, there is a need to provide coverage for the caregiver who loses income as a result of having to take time from work to care for an ill person such as a dependent or family member.

### BRIEF SUMMARY OF THE INVENTION

Generally described, various embodiments of the present invention provide an insurance policy which confers a benefit to a policy participant when the participant or a covered family member is confined to a hospital due to sickness or injury, or the participant misses work as a result of his or her own or a covered family member's sickness or injury. This benefit can be used by the policy participant as he or she sees fit to cover such out-of-pocket costs as travel expenses, lodging, child care, etc. or to supplement lost income due to missed work related to the care of a covered family member. Benefits under such a policy may be paid in addition to or independent of other insurance policies and benefits for any related illnesses. Systems and methods for issuing such an insurance policy and processing a claim under such an insurance policy are also provided.

According to one aspect of the present invention, a hospital confinement and care insurance policy is provided. The policy confers benefits in the form of one or more payments to be made to a policy participant as the result of the participant or a covered family member being confined to a hospital due to sickness or injury, or the participant missing work as a result of his or her own or a covered family member's sickness or injury.

Another aspect of the present invention is a system for issuing a hospital confinement and care insurance policy. The system is comprised of a processor and a memory coupled to the processor that stores a computer program executable by the processor. The processor executes the computer program to receive applicant data related to a prospective policy participant. Executing the computer program, the processor applies one or more business rules stored in the memory to the applicant data to determine whether the prospective participant qualifies for a hospital confinement and care insurance policy. The processor executes the computer program to transmit the hospital confinement and care insurance policy to the policy participant, if the policy participant is determined to qualify for the hospital confinement and care insurance policy.

Another aspect of the invention is a system for processing a claim under a hospital confinement and care insurance policy. The system is comprised of a processor and a memory connected to the processor that stores a computer program executed by the processor. The processor executes the computer program to receive a claim under the hospital confinement and care insurance policy from a policy participant, i.e., a policyholder of a hospital confinement and care insurance policy. The processor executes the computer program, causing such processor to determine whether the policy participant is eligible for one or more benefits provided by the hospital confinement and care insurance policy. If so, then the processor further executes the computer program to calculate the benefit amount and authorizes payment to the policy participant.

Yet another aspect of the present invention is a method of issuing a hospital confinement and care insurance policy. The method is comprised of the steps of receiving applicant data related to a prospective policy participant; determining, based at least in part on the applicant data, whether the prospective policy participant qualifies for the hospital confinement and care insurance policy; and, if the prospective policy participant does qualify, then issuing the hospital confinement and care insurance policy to the policy participant.

Another aspect of the present invention is a method of processing a hospital confinement and care insurance policy claim. The method is comprised of the steps of receiving a hospital confinement and care insurance policy claim from a policy participant; determining whether the policy participant is eligible for one or more benefits as the result of the participant or a covered family member being confined to a hospital due to sickness or injury, or the participant missing work as a result of his or her own or a covered family member's sickness or injury; and if the policy participant is eligible for a benefit, then authorizing payment of the benefit to the policy participant.

Yet another aspect of the present invention is a method of offering a hospital confinement and care insurance policy. The method is comprised of the steps of providing a hospital confinement and care insurance application to an applicant, wherein the hospital confinement and care insurance policy provides a benefit to a policy participant if the participant or a covered family member is confined to a hospital due to sickness or injury, or the participant misses work as a result of his or her own or a covered family member's sickness or injury; receiving the applicant's information from the applicant and determining whether the applicant is qualified to become a policy participant; and, if the applicant is so authorized, then issuing the hospital confinement and care insurance policy to the applicant, so that the applicant thus becomes a policy participant.

These and other aspects of the present invention are more fully described herein.

### BRIEF DESCRIPTION OF THE DRAWING(S)

Having thus described the invention in general terms, reference will now be made to the accompanying drawings, which are not necessarily drawn to scale, and wherein:

FIG. 1a is an illustration of one embodiment of a computer that can be used to practice aspects of the present invention;

FIG. 1b is an embodiment of a processing system having a distributed communication and processing architecture that may be used to practice aspects of the present invention;

FIG. 2 is a block diagram of a system for issuing a hospital confinement and care insurance policy according to one embodiment of the present invention;

FIG. 3 is a block diagram of an Insurance Company computer in accordance with one embodiment of the present invention;

FIG. 4 is a block diagram of a Computing Device in accordance with one embodiment of the present invention;

FIG. 5 is a flow chart illustrating a method of issuing a hospital confinement and care insurance policy according to an embodiment of the present invention;

FIG. 6 is a block diagram of a system for processing a hospital confinement and care insurance policy claim according to one embodiment of the present invention;

FIG. 7 is a block diagram of a Claim Processing Server in accordance with embodiments of the present invention;

FIG. 8 is a flow chart illustrating a method of processing a hospital confinement and care insurance policy claim according to an embodiment of the present invention; and

Appendix 1 is an example of an insurance policy document according to one embodiment of the present invention.

### DETAILED DESCRIPTION OF THE INVENTION

The present invention now will be described more fully with reference to the accompanying drawings, in which some, but not all embodiments of the invention are shown. Indeed, this invention may be embodied in many different forms and should not be construed as limited to the embodiments set forth herein. Rather, these embodiments are provided so that this disclosure will satisfy applicable legal requirements. Like numbers refer to like elements throughout.

As will be appreciated by one skilled in the art, the present invention may be embodied as a method, a data processing system, or a computer program product. Accordingly, the present invention may take the form of an entirely hardware embodiment, an entirely software embodiment, or an embodiment combining software and hardware aspects. Furthermore, the present invention may take the form of a computer program product on a computer-readable storage medium having computer-readable program instructions (e.g., computer software) embodied in the storage medium. More particularly, the present invention may take the form of web-implemented computer software. Any suitable computer-readable storage medium may be utilized including hard disks, CD-ROMs, optical storage devices, or magnetic storage devices.

The present invention is described below with reference to block diagrams and flowchart illustrations of methods, apparatuses (i.e., systems) and computer program products according to an embodiment of the invention. It will be understood that each block of the block diagrams and flowchart illustrations, and combinations of blocks in the block diagrams and flowchart illustrations, respectively, can be implemented by computer program instructions. These computer program instructions may be loaded onto a general purpose computer, special purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

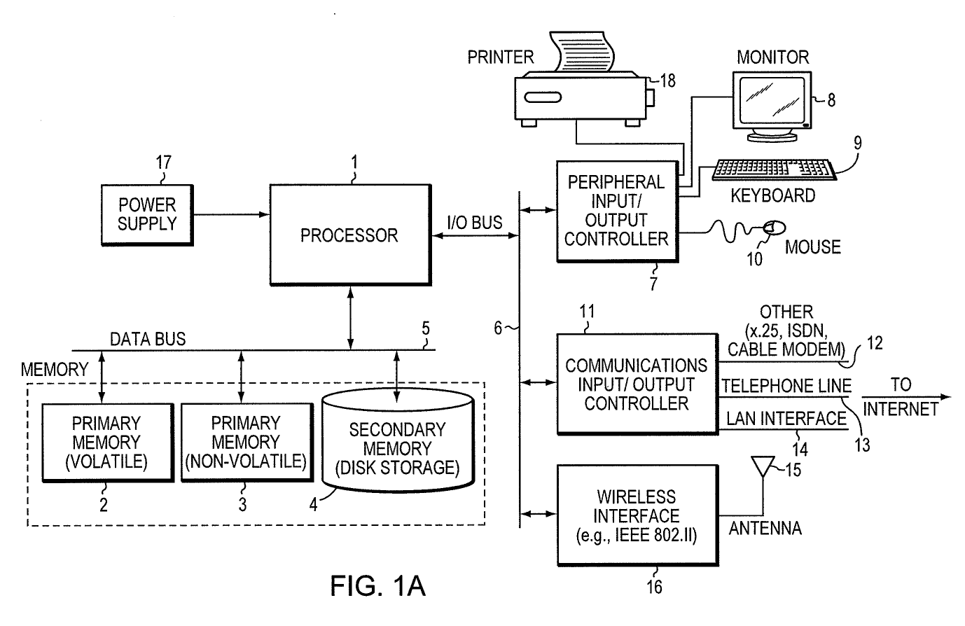

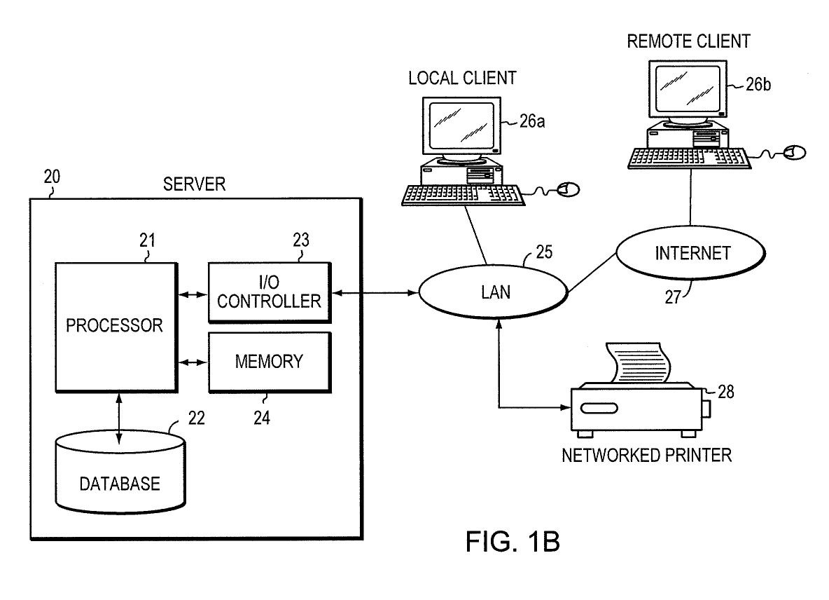

In several of the embodiments of the invention referenced herein, a “computer” is referenced. The computer may be, for example, a mainframe, desktop, notebook or laptop, or a hand held device such as a data acquisition and storage device, etc. In some instances the computer may be a “dumb” terminal used to access data or processors over a network. Turning to FIG. 1a, one embodiment of a computer is illustrated that can be used to practice aspects of the present invention. In FIG. 1a, a processor 1, such as a microprocessor, is used to execute software instructions for carrying out the defined steps. The processor 1 receives power from a power supply 17 that also provides power to the other components as necessary. The processor 1 communicates using a data bus 5 that is typically 16 or 32 bits wide (e.g., in parallel). The data bus 5 is used to convey data and program instructions, typically, between the processor and memory. In the present embodiment, memory can be considered primary memory 2 that is RAM or other forms which retain the contents only during operation, or it may be non-volatile memory 3, such as ROM, EPROM, EEPROM, FLASH, or other types of memory that retain the memory contents at all times. The memory could also be secondary memory 4, such as disk storage, that stores a large amount of data. In some embodiments, the disk storage may communicate with the processor using an I/O bus 6 instead of a dedicated bus (not shown). The secondary memory may be a floppy disk, hard disk, compact disk, DVD, or any other type of mass storage type known to those skilled in the computer arts.

The processor 1 also communicates with various peripherals or external devices using an I/O bus 6. In the present embodiment, a peripheral I/O controller 7 is used to provide standard interfaces, such as RS-232, RS-422, DIN, USB, or other interfaces as appropriate to interface various input/output devices. Typical input/output devices include local printers 18, a monitor 8, a keyboard 9, and a mouse 10 or other typical pointing devices (e.g., rollerball, trackpad, joystick, etc.).

The processor 1 typically also communicates using a communications I/O controller 11 with external communication networks, and may use a variety of interfaces such as data communication oriented protocols 12 such as X.25, ISDN, DSL, cable modems, etc. The communications controller 11 may also incorporate a modem (not shown) for interfacing and communicating with a standard telephone line 13. Finally, the communications I/O controller may incorporate an Ethernet interface 14 for communicating over a LAN. Any of these interfaces may be used to access the Internet, intranets, LANs, or other data communication facilities.

Finally, the processor 1 may communicate with a wireless interface 16 that is operatively connected to an antenna 15 for communicating wirelessly with another device, using for example, one of the IEEE 802.11 protocols, 802.15.4 protocol, or a standard 3G wireless telecommunications protocols, such as CDMA2000 1x EV-DO, GPRS, W-CDMA, or other protocol.

An alternative embodiment of a processing system that may be used is shown in FIG. 1b. In this embodiment, a distributed communication and processing architecture is shown involving a server 20 communicating with either a local client computer 26a or a remote client computer 26b. The server 20 typically comprises a processor 21 that communicates with a database 22, which can be viewed as a form of secondary memory, as well as primary memory 24. The processor 21 also communicates with external devices using an I/O controller 23 that typically interfaces with a LAN 25. The LAN 25 may provide local connectivity to a networked printer 28 and the local client computer 26a. These may be located in the same facility as the server 20, though not necessarily in the same room. Communication with remote devices 26b typically is accomplished by routing data from the LAN 25 over a communications facility to the Internet 27. A remote client computer 26b may execute a web browser, so that the remote client 26b may interact with the server as required by transmitted data through the Internet 27, over the LAN 25, and to the server 20.

Those skilled in the art of data networking will realize that many other alternatives and architectures are possible such as, for example, the handheld devices contemplated herein and can be used to practice the principles of the present invention. The embodiments illustrated in FIGS. 1a and 1b can be modified in different ways and be within the scope of the present invention as claimed.

### Hospital Confinement and Care Insurance Policy

A hospital confinement and care insurance policy (also referred to as a “hospital confinement care indemnity policy”), according to one embodiment of the invention, comprises hospital confinement and care benefits that provide one or more payments to a policyholder as the result of policyholder or a covered family member being confined to a hospital due to sickness or injury, or the policyholder missing work as a result of his or her own or a covered family member's sickness or injury.

An example of a hospital confinement and care insurance policy is provided in Appendix 1, according to one embodiment of the invention. In this exemplary embodiment, four benefit categories are available to the policy participant, or “named insured”, as detailed on pages 9-10 of Appendix 1:
A. Daily Hospital Confinement Benefit (benefit A)—a daily benefit amount is paid for each day of confinement of a covered person in a hospital.
B. Post-Hospitalization Care Recovery Benefit (benefit B)—a daily benefit amount is paid for a limited number of days after a covered confinement in a hospital.
C. Contagious Disease/Outpatient Surgical Recovery Benefit (benefit C)—a daily benefit amount is paid for each day the named insured misses work as a result of: 1) the suffering and medical treatment of a covered person from a covered contagious disease or upon advice from a covered person's physician; 2) the recovery of a covered person from a covered outpatient surgery; or 3) continued recovery of a covered person from a covered hospital confinement beyond the limitations of benefit B.
D. Family Support Benefit (benefit D)—a benefit is paid at the end of each period, the period comprising a pre-defined number of days, during which a covered person was subject to a covered hospital confinement throughout the entire period.

In this exemplary embodiment of the invention, the scope of persons covered by the hospital confinement and care insurance policy depends on the type of coverage selected by the policy participant. As provided on page 5 of Appendix 1, a participant can select Individual coverage, covering only himself or herself; Named Insured/Spouse Only coverage, under which only the participant and his or her legally married spouse are covered persons; One-Parent Family coverage, covering the participant and his or her dependent children; or Two-Parent Family coverage, where the participant, his or her spouse, and their dependent children all qualify as covered persons. Further, in this example, a hospital confinement is defined as a covered person being registered as an inpatient at a qualifying hospital or being assigned a bed for a predefined period of time (e.g. 23 or more hours) as an outpatient at such a facility. Consecutive confinements are generally considered the same confinement unless the result of an entirely unrelated sickness or injury or separated by 30 or more days of no confinement in any institution or facility. Other definitions also apply to this embodiment of the hospital confinement and care insurance policy as presented on pages 3-6 of Appendix 1.

Each benefit payable under a hospital confinement and care insurance policy may be subject to maximums or other limitations. For example, in the exemplary embodiment shown in Appendix 1, benefit A is conferred for a maximum of 365 days per confinement, while benefit B is limited to a minimum of 5 days and a maximum of 90 days or the length of the confinement, whichever is less. Benefit C is paid for a maximum 5 days for individual coverage or 10 days for family coverage per policy year, and not conferred for any day covered by benefit A or B. Further, benefit D is limited to 12 payments per covered confinement. It is to be recognized that these maximums and limitations are only exemplary in nature and that other maximums or limitations are considered within the scope of the embodiments of the invention.

In addition, the scope of coverage may be further limited by policy exclusions and limitations. For example, pages 6-7 of Appendix 1 provide exclusionary periods for pre-existing conditions and other sickness diagnosed before the effective date of the policy as well as sickness or injury which will not qualify a covered person for benefits under the hospital confinement and care insurance policy, such as those resulting from:
intentionally self-inflicting bodily injury or attempting suicide;
participating in or attempting to participate in any illegal activity that is classified as a felony, whether charged or not;
being exposed to war or any act of war, declared or undeclared, or actively serving in any of the armed forces or units auxiliary thereto, including the National Guard or Reserve;
having treatment for a mental or nervous illness, disease, or disorder, including, but not limited to: depression, stress, and anxiety;
alcoholism or drug dependency;
any loss sustained or contracted due directly or indirectly, to a covered person's being intoxicated or under the influence of alcohol, drugs, any narcotic, or chemical substance unless administered on the advice of a physician and taken according to the physician's instructions;
having cosmetic surgery that is not medically necessary;
having elective surgery that is not medically necessary within the first 12 months of the effective date of the policy;
pregnancy or childbirth within the first ten months of the effective date of the policy;
routine nursing or well-baby care for a newborn child; and
donating an organ within the first 12 months of the effective date of the policy.
   In other embodiments of the invention, the limitations may be narrower or broader, depending on the scope of coverage desired by the issuing insurance company or policy participants.

The hospital confinement and care insurance policy provides a policy schedule that details the named insured, i.e. the policy participant, the type of coverage elected, the effective dates of the coverage, and the premium amount to be paid. In the exemplary embodiment depicted on page 2 of Appendix 1, the policy schedule also includes the mode of payment selected by the policy participant, e.g. monthly, quarterly, annually, etc., as well as the policy number and coverage indicators for the policy. The policy schedule is signed by representatives of the Insurance Company offering the policy indicating acceptance of the policy conditions by the insurer.

### System for Issuing Hospital Confinement and Care Insurance Policies

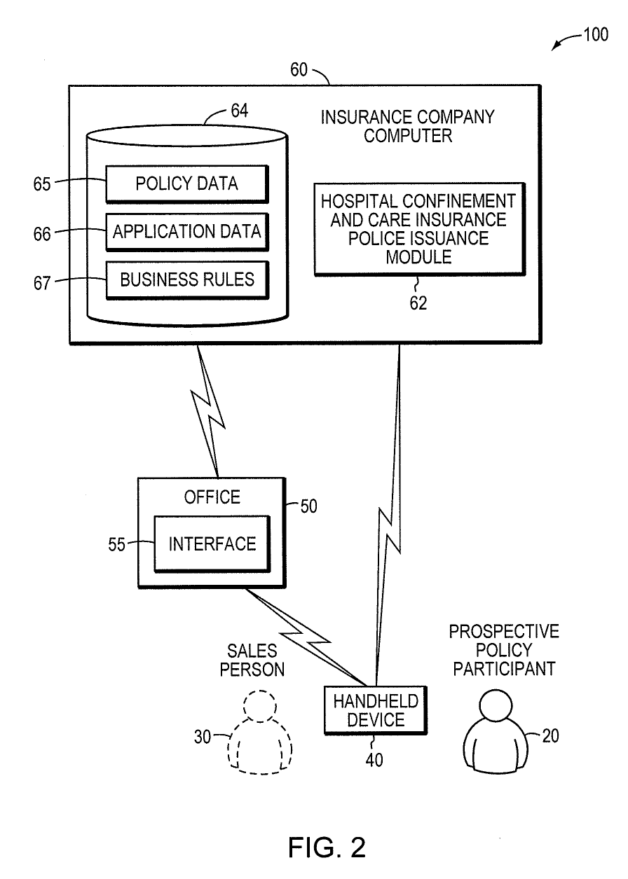

FIG. 2 shows a block diagram of a system for issuing a hospital confinement and care policy 100 in accordance with various embodiments of the present invention. As may be understood from this figure, the system 100 may include a prospective policy participant 20 in contact with a salesperson 30 having a computing device 40, into which the salesperson 30 can enter applicant data 66 received from the prospective policy participant 20. Applicant data 66 may include information identifying the person or persons to be covered and their personal characteristics (e.g., age, sex, height, weight, etc.), the desired coverage and limits, the person's medical history, etc. As can be appreciated by one of ordinary skill in the art, the computing device 40 may be any type of computing device, including, for example, a mobile telephone, personal data assistant (PDA), laptop or mobile personal computer (PC), desktop unit, or workstation.

The system further includes an office 50 in communication with the handheld device 40, and an Insurance Company computer 60 in communication with the office 50. The office 50, which may be operated directly by the Insurance Company or by some other entity affiliated with the Insurance Company, includes at least an interface 55 to facilitate the communication of applicant data between the handheld device 40 and the Insurance Company computer 60. The interface 55 may be any known interface including, for example, a docking station that is connected to an IT infrastructure, such as a Local Area Network (LAN), Wide Area Network (WAN), or the Internet. Data can, therefore, be communicated from the office 50 to the Insurance Company computer 60 via any known means of communicating data including, for example, via the Internet, via a cable connection, by fax, via a telephone network, or even by a human operator located at the office 50.

Alternatively, the computing device 40 can be configured to communicate with the insurance company computer 60 directly without the need for office 50 and the interface 55. The computing device 40 can communicate with the Insurance Company computer 60 via a communications network such as the Internet, WAN, one or more LANs, wireless network, cellular network, etc.

The Insurance Company computer 60 includes at least a hospital confinement and care insurance policy issuance module 62. The module 62 can be configured to retrieve data from, and store data to, a database 64. As shown, the database 64 contains policy data 65 which defines the coverage, terms, limitations, exclusions, etc. of the insurance policy as well as the criteria for acceptance of an applicant for coverage or adjudicating claims under the hospital confinement and care insurance policy. Applicant data 66 related to a prospective applicant or policy holder can also be stored in the database 64. Further, business rules 67 can each be stored in the database 64 and accessed by the hospital confinement and care insurance policy issuance module 62 upon execution by the Insurance Company Computer 60. The business rules 67 define the rules that govern the acceptance or rejection of an applicant for coverage under the policy, or the rules that govern adjudication of a claim under the policy. For example, the Insurance Company Computer 60 can be configured to compare applicant data 66 of a prospective applicant to policy data 65 and apply the business rules 67 to determine whether the prospective applicant qualifies for coverage under the policy.

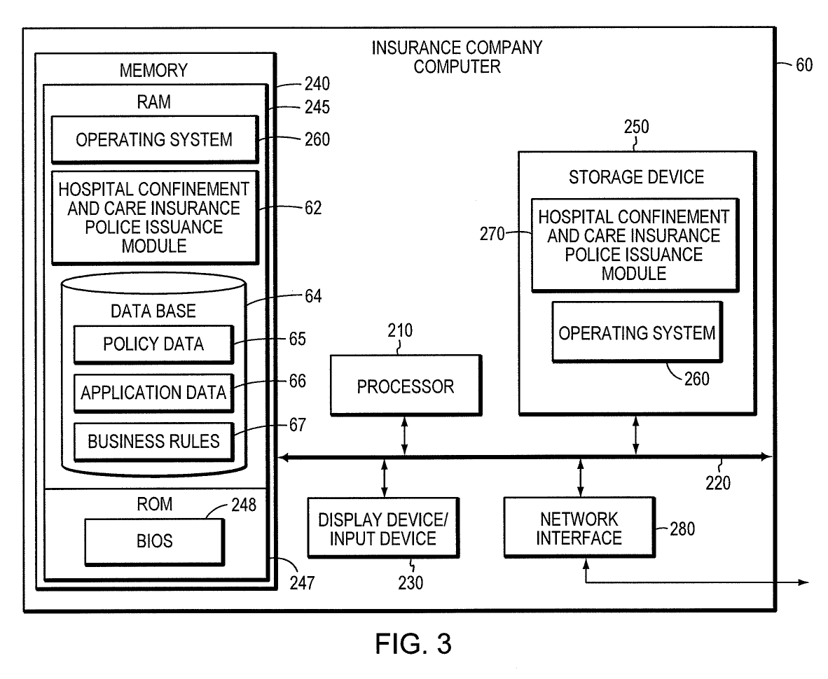

FIG. 3 shows an exemplary schematic diagram of the Insurance Company computer 60 according to one embodiment of the invention. The Insurance Company computer 60 includes a processor 210 that communicates with other elements within the Insurance Company computer 60 via a system interface or bus 220. The processor 210 could be, for example, a central processing unit, microprocessor, microcontroller, programmable gate array, or some other device that processes data. Also included in the Insurance Company computer 60 is a display device/input device 230 for receiving and displaying data. The unit 230 may include, for example, an input device such as a keyboard, mouse or pointing device, and a display device such as a monitor, cathode ray tube (CRT), liquid crystal display (LCD), or other such device. The Insurance Company computer 60 further includes a memory 240, which includes both random access memory (RAM) 245 and read only memory (ROM) 247. The computer's ROM 247 is used to store a basic input/output system 248 (BIOS), containing the basic routines that help to transfer information between elements within the Insurance Company computer 60. The computer's RAM 245 is used to store the policy data 65, applicant data 66 and business rules 67.

In addition, the Insurance Company computer 60 includes at least one storage device 250, such as a hard disk drive, a floppy disk drive, a CD-ROM drive, or optical disk drive, for storing information on various computer-readable media, such as a hard disk, a removable magnetic disk, or a CD-ROM disk. As will be appreciated by one of ordinary skill in the art, each of these storage devices 250 is connected to the system bus 220 by an appropriate interface. The storage devices 250 and their associated computer-readable media provide nonvolatile storage for a personal computer. It is important to note that the computer-readable media described above could be replaced by any other type of computer-readable media known in the art. Such media include, for example, magnetic cassettes, flash memory cards, digital video disks, and Bernoulli cartridges.

A number of program modules may be stored by the various storage devices 250 and within RAM 245. Such program modules include an operating system 260, and the hospital confinement and care insurance policy issuance module 270. The hospital confinement and care insurance issuance module 270 controls certain aspects of the operation of the Insurance Company computer 60, as is described in more detail below, with the assistance of the processor 210 and the operating system 260.

Also located within the Insurance Company computer 60 is a network interface 280, for interfacing and communicating with other elements of a computer network. It will be appreciated by one of ordinary skill in the art that one or more of the Insurance Company computer 60 components may be located geographically remotely from other Insurance Company computer 60 components. Furthermore, one or more of the components may be combined, and additional components performing functions described herein may be included in the Insurance Company computer 60.

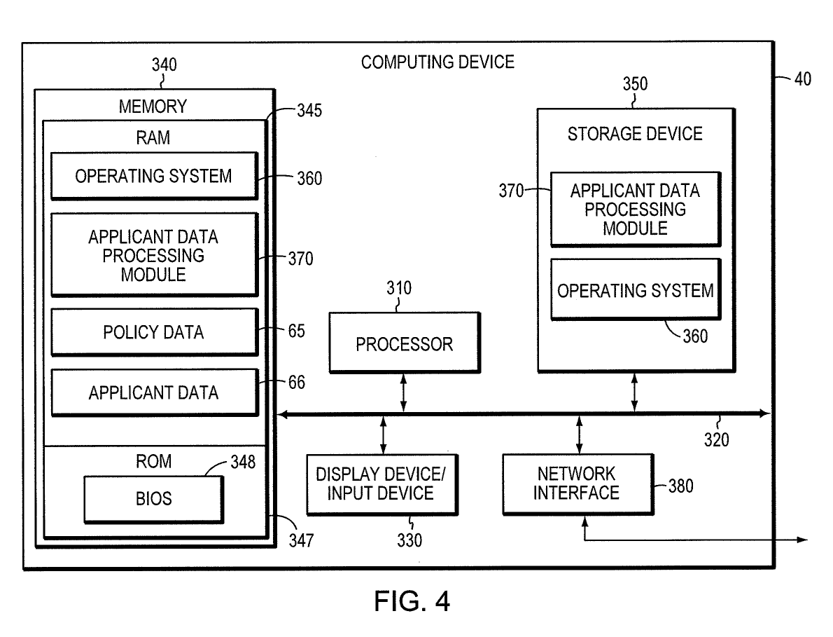

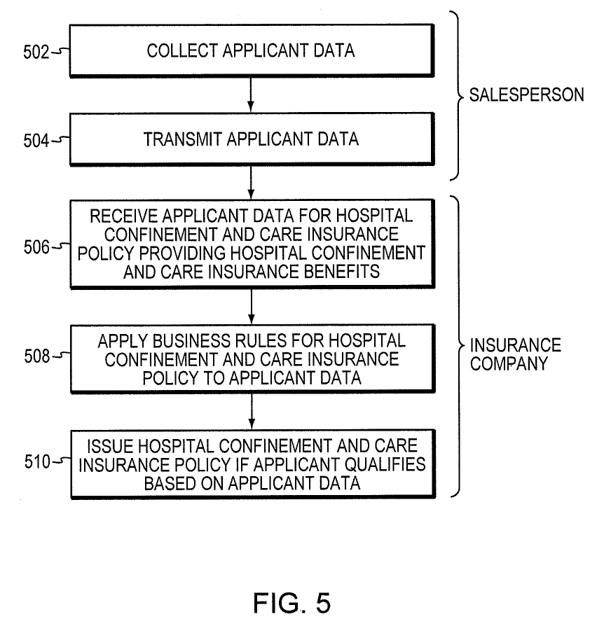

FIG. 4 shows an exemplary schematic diagram of the Computing Device 40 according to one embodiment of the invention. The Computing Device 40 is used by the prospective policy participant 20 or the salesperson 30, or both, to receive applicant data 66 and to transfer the same to the Insurance Company computer 60. The elements of the Computing Device 40 shown in FIG. 5 are the same or similar to corresponding elements of the Insurance Company computer 60 shown in FIG. 4, with a few exceptions. In particular, the Computing Device 40 includes a processor 310 that communicates with other elements within the Computing Device 40 via a system interface or bus 320, a display device/input device 330 for receiving and displaying data, a memory 340, which includes both random access memory (RAM) 345 and read only memory (ROM) 347, wherein the ROM 347 is used to store a basic input/output system 348 (BIOS) and the RAM 345 is used to at least temporarily store policy data 65 and applicant data 66, at least one storage device 350, and a network interface 380, for interfacing and communicating with other elements of a computer network.

Like the Insurance Company computer 60, a number of program modules may be stored by the various storage devices 350 and within RAM 345. Such program modules include an operating system 360, and an applicant data processing module 370. The applicant data processing module 370 controls certain aspects of the operation of the Computing Device 40, as is described in more detail below, with the assistance of the processor 310 and the operating system 360.

### Method of Issuing a Hospital Confinement and Care Insurance Policy

FIG. 5 illustrates the steps taken when issuing the above described hospital confinement and care insurance policy according to one embodiment of the present invention. As shown, in one embodiment the process of issuing a hospital confinement and care insurance policy begins at Step 502 in which a salesperson collects applicant data 66 from a prospective policy participant and enters it into his or her computing device 40. In Step 504, the salesperson transmits the applicant data 66 from the computing device 40 to the Insurance Company computer 60 using the application data processing module 370 on the computing device 40. The applicant data collected may include, for example, the prospective policy participant's name, address or medical history, and/or other types of insurance coverage owned by the prospective policy participant.

In other embodiments, the process could likewise begin with a prospective policy participant entering his or her own applicant data directly into an application form provided by the Insurance Company, and sending the application form to the Insurance Company. The application form could be in hard copy, requiring, for example, that the prospective policy participant enter the applicant data by hand, and then mail or fax the form to the Insurance Company. The applicant data could then be entered into the Insurance Company computer 60 by, for example, an Insurance Company employee. Alternatively, the application form could be provided over the Internet on a website operated by the Insurance Company, or by some other company affiliated with the Insurance Company. In this case the prospective policy participant could merely enter the data into the online version of the application form and then send the data electronically to the Insurance Company computer 60. In yet another embodiment, the prospective policy participant may contact an Insurance Company operator directly, by telephone or by other means, and communicate the applicant data to the operator, the data is then input into the Insurance Company computer 60 by the operator or another associated individual.

Once the Insurance Company computer 60 has received the applicant data 66, in Step 506, the Insurance Company computer 60 stores the applicant data 66 in a database 64 on the Insurance Company computer 60. The processor 210 executes the hospital confinement and care insurance policy issuance module 62 to apply business rules 67, which are also stored in the database 64 on the Insurance Company computer 60, to the applicant data 66 to determine whether the prospective policy participant qualifies for the hospital confinement and care insurance policy (Step 508). This may include, for example, checking the applicant's name and address to determine whether they are valid, authenticating the applicant to ensure that the applicant is who he/she claims to be, determining whether the applicant is financially responsible based on a credit or payment history check, for example, determining whether the medical history and status of applicant and other persons to be covered are within risk parameters of the policy, determining whether the applicant and other persons to be covered have pre-existing conditions that should be excluded from policy coverage, determining whether the applicant is of legal age to enter a binding contract in the State in which a policy is sought, etc.

If the Insurance Company computer 60 determines that the applicant is not qualified for the policy based on the applicant data 66 and business rules 67, then the Insurance Company computer 60 rejects the application. Conversely, upon a determination by the Insurance Company computer 60 that the prospective policy participant qualifies for the hospital confinement and care insurance policy, in Step 510 the Insurance Company issues the hospital confinement and care insurance policy to the policy participant by, for example, generating policy data 65 that is specific to the prospective policy participant, storing the policy data 65 in the database 64, and transmitting the policy data 65 to the policy participant. The policy data 65 may be sent, for example, electronically, by mail, by fax or delivered by hand, to the policy participant directly, or via the salesperson.

### System for Processing Hospital Confinement and Care Insurance Policy Claims

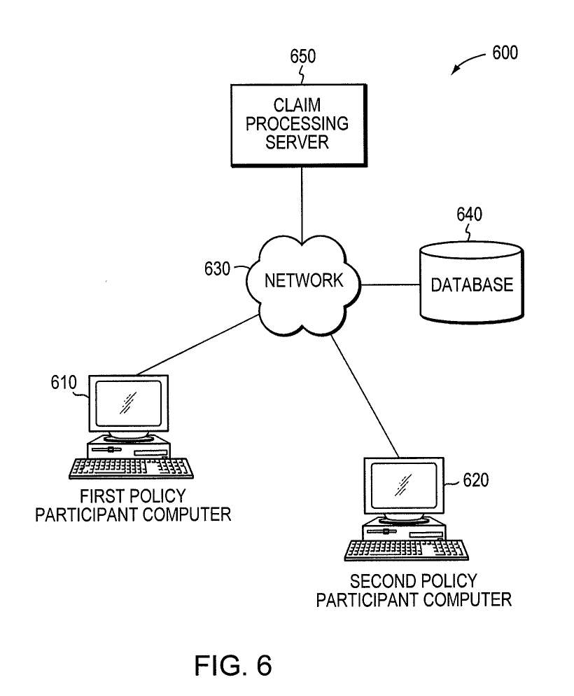

FIG. 6 shows a block diagram of a system 600 for processing a hospital confinement and care insurance policy claim in accordance with various embodiments of the present invention. As may be understood from this figure, the system 600 may include one or more policy participant computers 610, 620 that are connected, via a network 630 (e.g., a Local Area Network (LAN), wide area network (WAN), Internet, etc.), to a Claim Processing Server 650. In one embodiment, the Claim Processing Server 650 is configured to retrieve data from, and store data to, a database 640 that may be stored on (or, alternatively, stored remotely from) the Claim Processing Server 650.

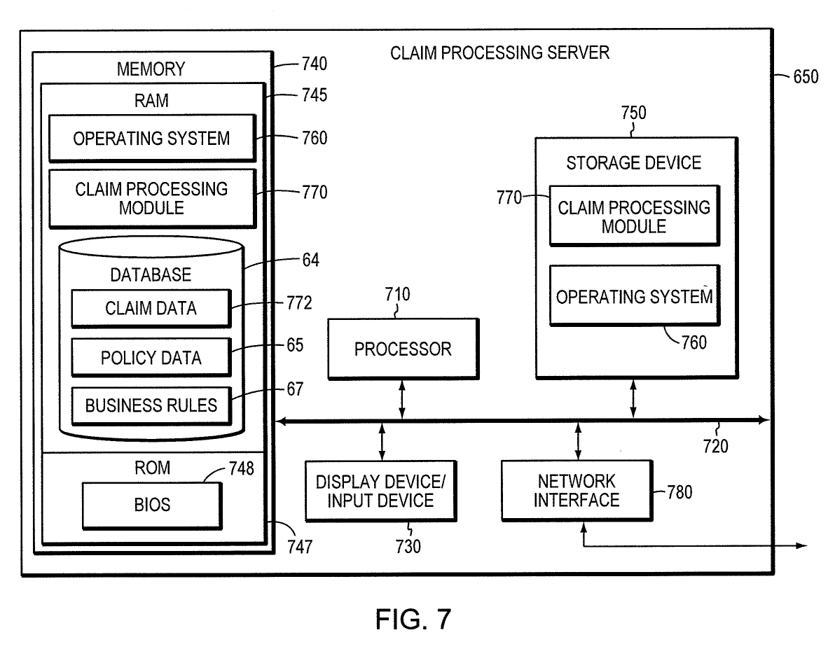

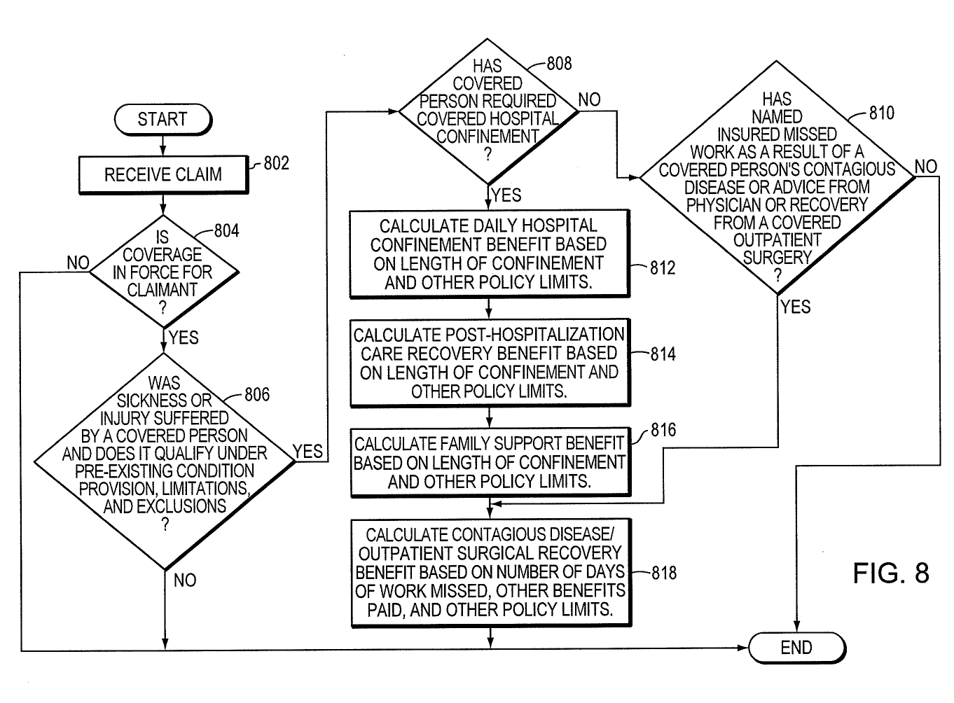

FIG. 7 shows a schematic diagram of the Claim Processing Server 650 according to one embodiment of the invention. The elements of the Claim Processing Server 650 shown in FIG. 8 are the same or similar to corresponding elements of the Insurance Company computer 60 shown in FIG. 4 and of the Computing Device 40 shown in FIG. 5, with a few exceptions. In particular, the Claim Processing Server 650 includes a processor 710 that communicates with other elements within the Claim Processing Server 650 via a system interface or bus 720, a display device/input device 730 for receiving and displaying data, a memory 740, which includes both random access memory (RAM) 745 and read only memory (ROM) 747, wherein the ROM 747 is used to store a basic input/output system 748 (BIOS), at least one storage device 750, and a network interface 780, for interfacing and communicating with other elements of a computer network.

Like the Insurance Company computer 60 and the Computing Device 40, a number of program modules may be stored by the various storage devices 750 and within RAM 745. Such program modules include an operating system 760, and a claim processing module 770. The claim processing module 770 controls certain aspects of the operation of the Claim Processing Server 650, as is described in more detail below, with the assistance of the processor 710 and the operating system 760.

### Method of Processing a Hospital Confinement and Care Insurance Policy Claim

FIG. 8 depicts a process of the Claim Processing Module 770 as it is executed by processor 710 according to one embodiment of the invention. In general, this figure illustrates the steps taken when adjudicating a claim received from a hospital confinement and care insurance policy participant according to various embodiments of the present invention. In the adjudication process, the Claims Processing Server 60 compares the claim data 772 with the policy data 65 and applies the business rules 67 to the result of the comparison to determine whether the claim should be allowed, and if so, under what terms it should be paid. As may be understood from this figure, the process begins at Step 802 in which the processor 710 executes the Claim Processing Module 770 on the Claim Processing Server 650 to receive claim data 772 for benefit under the policy resulting from the hospital confinement of a covered person and/or missed days of work by the policy participant. As will be understood by those of skill in the art, the claim data 772 may have been communicated by the policy participant, for example, by telephone, mail, fax, or network (e.g., the Internet) or may be forwarded by an employer or third-party claim adjudicator by electronic, optical, or wireless media, for example. Once received, the Claim Processing Server 650 executes the Claim Processing Module 770, in one embodiment, to determine, based on the received claim data 772, business rules 67, and policy data 65 such as the effective dates from the policy participant's hospital confinement and care insurance policy schedule, whether the policy participant has current coverage in force under the policy at Step 804. If the processor 710 determines at Step 804 that the policy participant does have coverage in force, then at Step 806 it is determined whether the sickness or injury resulting in the claim was suffered by a covered person and qualifies for coverage under the policies pre-existing condition provision, limitations, and exclusions defined by policy data 65 and business rules 67, as described above. The policy participant may be required to submit, along with the claim for benefit, an invoice, hospital admission form, or treatment form from a physician to support the qualification of the benefit. In other embodiments, the Insurance Company can receive and store in a database accessible to the processor 710 executing the Claim Processing Module 770 claim data 772 that reflects hospital confinement and treatment incurred by covered persons directly from participating hospitals and treatment facilities. By using the claim data 772, the Claim Processing Server 650 can execute the Claim Processing Module 770 to check the database 64 to determine whether the confinement was incurred by a covered person and whether the sickness or injury qualifies for benefit under the participant's policy.

If, at Step 806, it is found that the sickness or injury qualifies under policy provisions for benefit, the Claims Processing Server 60 executes the Claim Processing Module 770, in one embodiment, to determine the benefit to be conferred as a result of the claim under each of the benefit categories described above. If, for example, it is determined at step 808 that the claim for benefit results from a covered hospital confinement of a covered person, the module proceeds to calculate the benefit to be paid under benefit category A at step 812, based on the number of days of confinement subject to any maximum limit and other limitations specified in the policy. The module then calculates the benefit to be paid under benefit category B at step 814, based on the number of days of confinement subject to the minimum and maximum limitations described above. The module then calculates the benefit to be paid under benefit category D at step 816, based on the number of days of confinement subject to the limit on the number of payments described above. And finally, the module calculates the benefit to be paid under benefit category C at step 818, based on the number of days of work missed by the policy participant, the benefits already paid under benefit categories A and B, and the maximum limitations based on the type of coverage elected by the policy participant.

If, however, it is determined at step 808 that the claim for benefit does not result from a covered hospital confinement, the Claim Processing Server 650 continues to execute the Claim Processing Module 770 to determine at step 810 whether the claim results in the policy participant missing work to care for a covered person suffering from a contagious disease or recovering from a covered outpatient surgery. If so, the module calculates the benefit to be paid under benefit category C at step 818, based on the number of days of work missed by the policy participant and the maximum limitations based on the type of coverage elected by the policy participant.

As will be understood by those of ordinary skill in the art, the steps of process described above need not be performed in the order in which they are described above. For instance, it is not necessary that the Claim Processing Server 650, as it executes the Claim Processing Module 770, determine whether the sickness or injury qualify under the policy provisions before determining whether the claim results from a covered hospital confinement or missed work by the policy participant, as long as all necessary determinations are made to assess what benefits the policy participant should receive.

### MODIFICATIONS AND ALTERNATIVE EMBODIMENTS

Many modifications and other embodiments of the invention will come to mind to one skilled in the art to which this invention pertains having the benefit of the teachings presented in the foregoing descriptions. Accordingly, it should be understood that the invention is not to be limited to the specific embodiments disclosed and that modifications and other embodiments are intended to be included within the scope of the appended exemplary inventive concepts. Although specific terms are employed herein, they are used in a generic and descriptive sense only and not for purposes of limitation.

What is claimed is:

1. A hospital confinement and care insurance policy providing:
a benefit in the form of one or more payments to be made to a policy holder of said policy as the result of:
said policy holder or a covered member of said policy holder's family being confined to a covered hospital or facility due to sickness or injury; or
said policy holder missing work as a result of sickness or injury of said policy holder or a covered member of said policy holder's family.

2. A system for issuing a hospital confinement and care insurance policy comprising:
a processor; and
a memory coupled to the processor that stores a computer program executable by the processor to:
receive applicant data related to a prospective applicant for a hospital confinement and care insurance policy;
apply one or more business rules for the hospital confinement and care insurance policy stored in the memory to the applicant data to determine whether said prospective applicant qualifies for the hospital confinement and care insurance policy; and
transmit the hospital confinement and care insurance policy to a policyholder, wherein said policy holder is comprised of the prospective applicant determined to qualify for the hospital confinement and care insurance policy,
wherein said hospital confinement and care insurance policy provides a benefit in the form of one or more payments to a policy holder as the result of said policy holder or a covered member of said policy holder's family being confined to a hospital due to sickness or injury, or said policy holder missing work as a result of sickness or injury of said policy holder or a covered member of said policy holder's family.

3. A system as claimed in claim 2 wherein the processor applies the business rules to the applicant data to check the applicant's name and address to determine whether they are valid.

4. A system as claimed in claim 2 wherein the processor applies the business rules to the applicant data to authenticate the applicant to ensure that the applicant is who he/she claims to be.

5. A system as claimed in claim 2 wherein the processor applies the business rules to the applicant data to determine whether the applicant is financially responsible based on a credit or payment history check.

6. A system as claimed in claim 2 wherein the processor applies the business rules to the applicant data to determine whether the medical history and status of applicant and other persons to be covered are within risk parameters of the policy.

7. A system as claimed in claim 2 wherein the processor applies the business rules to the applicant data to determine whether the applicant and other persons to be covered have pre-existing conditions that should be excluded from policy coverage.

8. A system as claimed in claim 2 wherein the processor applies the business rules to the applicant data to determine whether the applicant is of legal age to enter a binding contract in the State in which a policy is sought, etc.

9. A system for processing a hospital confinement and care insurance policy claim comprising:
a processor; and
a memory connected to the processor that stores a computer program executed by the processor to:
receive a hospital confinement and care insurance policy claim from a policyholder of a hospital confinement and care insurance policy;
determine the eligibility of the policyholder for one or more benefits of said policy;
calculate the benefit amount to be paid to said policyholder based upon said eligibility determination; and
authorize payment of said benefit to said policyholder,
wherein said hospital confinement and care insurance policy provides a benefit in the form of one or more payments to a policyholder as the result of said policyholder or a covered member of said policyholder's family being confined to a hospital due to sickness or injury, or said policyholder missing work as a result of sickness or injury of said policyholder or a covered member of said policyholder's family.

10. A system as claimed in claim 9 wherein the processor determines the eligibility of the policy holder for one or more benefits of said policy based on effective date and term of coverage of the policy as compared to a hospitalization date or dates of a covered person for a claim under the policy.

11. A system as claimed in claim 9 wherein the processor determines the eligibility of the policy holder for one or more benefits of said policy based on whether sickness or injury was suffered by a covered person not qualifying as a pre-existing condition, limitation or exclusion.

12. A system as claimed in claim 9 wherein the processor determines eligibility of the policy holder for one or more benefits based on hospital confinement of a covered person under the policy.

13. A system as claimed in claim 9 wherein the processor determines eligibility of the policy holder for one or more benefits based on a covered person missing work as a result of a covered person's contagious disease, physician advice or recovery from a covered outpatient surgery.

14. A system as claimed in claim 9 wherein the processor calculates the benefit amount based on a daily benefit amount for each day of confinement of a covered person in a hospital.

15. A system as claimed in claim 9 wherein the processor calculates the benefit amount based on a daily benefit amount paid for a limited number of days after a covered confinement in a hospital.

16. A system as claimed in claim 9 wherein the processor calculates the benefit amount based on a daily benefit amount paid for each day the named insured misses work as a result of: 1) the suffering and medical treatment of a covered person from a covered contagious disease or upon advice from a covered person's physician; 2) recovery of a covered person from a covered outpatient surgery; or 3) continued recovery of a covered person from a covered hospital confinement beyond a daily benefit amount paid for a limited number of days after a covered confinement in a hospital.

17. A system as claimed in claim 9 wherein the processor calculates the benefit amount based on a family support benefit paid at the end of each period of a pre-defined number of days during which a covered person was subject to a covered hospital confinement throughout the entirety of the period.

18. A system as claimed in claim 9 wherein the processor calculates eligibility of the policy holder by applying business rules defining a hospital confinement as a covered person being registered as an inpatient at a qualifying hospital or being assigned a bed for a predefined period of time (e.g. 23 or more hours) as an outpatient at such a facility.

19. A system as claimed in claim 9 wherein the processor determines eligibility of the policy holder by determining a benefit payable under the hospital confinement and care insurance policy is payable only for a limited number of days of hospital confinement.

20. A method of issuing a hospital confinement and care insurance policy comprising the steps of:
receiving applicant data related to a prospective applicant;
determining, based at least in part on the applicant data, whether the prospective applicant qualifies for the hospital confinement and care insurance policy; and
issuing the hospital confinement and care insurance policy to a policyholder, wherein said policyholder is comprised of said prospective applicant determined to qualify for said hospital confinement and care insurance policy,
wherein said hospital confinement and care insurance policy provides a benefit in the form of one or more payments to a policyholder as the result of said policyholder or a covered member of said policyholder's family being confined to a hospital due to sickness or injury, or said policyholder missing work as a result of sickness or injury of said policyholder or a covered member of said policyholder's family 21. A method of processing a hospital confinement and care insurance policy claim comprising the steps of:
receiving a hospital confinement and care insurance policy claim from a policyholder of a hospital confinement and care insurance policy;
determining whether said policyholder is eligible for one or more benefits as the result of said policyholder or a covered member of said policyholder's family being confined to a hospital due to sickness or injury, or said policyholder missing work as a result of sickness or injury of said policyholder or a covered member of said policyholder's family;
calculating the benefit amount to be paid to said policyholder based upon said eligibility determination; and
authorizing payment of said benefit amount to said policyholder.

21. A method of offering a hospital confinement and care insurance policy comprising the steps of:
providing a hospital confinement and care insurance application to an applicant, wherein said hospital confinement and care insurance policy provides a benefit in the form of one or more payments to a policyholder as the result of said policyholder or a covered member of said policyholder's family being confined to a hospital due to sickness or injury, or said policyholder missing work as a result of sickness or injury of said policyholder or a covered member of said policyholder's family;
receiving said applicant's information from the applicant;
determining whether said applicant is qualified to become a policyholder of said hospital confinement and care insurance policy; and
issuing said hospital confinement and care insurance policy to the policyholder, wherein said policyholder is comprised of said applicant determined to qualify for said hospital confinement and care insurance policy.
